(19) United States
(12) Patent Application Publication
(10) Pub. No.: US 2025/0191592 A1
(43) Pub. Date: Jun. 12, 2025

(54) SYSTEMS AND METHODS FOR IMPROVED AUTOMATIC SPEECH RECOGNITION ACCURACY

(71) Applicant: RingCentral, Inc., Belmont, CA (US)

(72) Inventors: Sushant Hiray, Redwood City, CA (US); Ravi Kalluri, San Jose, CA (US)

(73) Assignee: RingCentral, Inc., Belmont, CA (US)

(21) Appl. No.: 18/537,191

(22) Filed: Dec. 12, 2023

(51) Int. Cl. G10L 17/26; G10L 17/18

(52) U.S. Cl. CPC G10L 17/26; G10L 17/18

(57) ABSTRACT

Disclosed is an dynamic speech recognition system and associated methods for improving speech recognition accuracy by biasing, tuning, and/or otherwise adjusting a speech recognition model to account or compensate for different speech characteristics of individual speakers and/or different environmental factors that have different effects on the characteristics of the audio recorded from each speaker. The system receives an audio stream, identifies a speaker in the audio stream, selects a first vector that is generated by a first machine learning model and that encodes speech characteristics of the speaker, selects a second vector that is generated by a second machine learning model and that encodes audio characteristics that affect a capture of the audio stream, and adjusts a third machine learning model based on the first vector and the second vector. The system uses the third machine learning model after it is adjusted to convert speech into text.

### TECHNICAL FIELD

The present disclosure relates generally to the field of audio processing. More specifically, the present disclosure relates to systems and methods for improving the accuracy of automatic speech recognition and transcription.

### BACKGROUND

Automatic speech recognition (“ASR”) services convert dialog into text. The ASR services produce a transcription of the speech.

Different users may speak with different accents, may pronounce words differently, and/or may have other variations in their speech relative to other speakers. Moreover, the speech of different speakers may be recorded with different microphones and encoded at different quality levels which may cause further variation in the speech of the different speakers.

These and other variations may introduce errors or inaccuracies in the speech-to-text conversion. For instance, an ASR service may be trained to recognize a first pronunciation of a word with voice characteristics associated with a first accent, and may be unable to recognize or detect the same word spoken with a second pronunciation or voice characteristics associated with a second accent.

Other environmental factors may reduce the transcription accuracy of the ASR service. For instance, excessive background noise, echo, reverberations, insufficient microphone gain, and/or other such environmental factors may distort the audio encoding. The environmental factors and the distorted audio may prevent the ASR service from isolating the speech and/or accurately transcribing the speech.

### BRIEF DESCRIPTION OF THE DRAWINGS

FIG. 1 illustrates an example architecture for performing dynamic speech recognition and transcription using a speaker adaptation model and an environment adaptation model in accordance with some embodiments presented herein.

FIG. 2 illustrates an example of dynamically customizing speech recognition for different speech characteristics of different users and for different audio characteristics of different audio capture devices and environments based on output from the speaker adaptation model and/or the environmental adaptation model in accordance with some embodiments presented herein.

FIG. 3 illustrates an example of the speaker adaptation model defining speaker-specific vectors based on the unique speech characteristics of a particular speaker in accordance with some embodiments presented herein.

FIG. 4 illustrates an example of the environment adaptation model defining environment-specific vectors based on the audio characteristics of an audio capture device in accordance with some embodiments presented herein.

FIG. 5 illustrates an example of defining environment-specific vectors based on the audio characteristics of a room in accordance with some embodiments presented herein.

FIG. 6 presents a process for dynamically customizing the speech recognition and transcription for different audio streams of a conference using different speaker-specific vectors and environment-specific vectors in accordance with some embodiments presented herein.

### DETAILED DESCRIPTION OF PREFERRED EMBODIMENTS

The current disclosure provides a technological solution to the technological problem of sound, signal, or audio processing. Specifically, the technological solution improves the accuracy of automatic speech recognition (“ASR”) by biasing, tuning, and/or otherwise adjusting a speech recognition model to account or compensate for different speech characteristics of individual speakers and/or different environmental factors that have different effects on the characteristics of the audio recorded from each speaker. In other words, the technological solution involves dynamically adjusting the ASR for each speaker involved in a conversation based on the individual speaker's accent, word pronunciation, and/or other speech characteristic variations, and further based on different background noises, echoes, reverberations, microphone qualities, and/or other environmental factors that may have different effects on the audio characteristics of each audio stream that is provided to the ASR for transcription.

The technological solution is embodied in a dynamic speech recognition system (“DSRS”) and associated methods. The DSRS uses a speaker adaptation model to detect and account for the different speech characteristics of each speaker in a conversation or conference and to generate a first set of vectors based on the different speech characteristics. The DSRS also uses an environment adaptation model to detect and account for the environmental factors that have different effects on the audio streams of the conversation or conference provided for transcription and to generate a second set of vectors based on the environmental factors. The DSRS adapts vectors of a speech recognition model according to the first set of vectors and the second set of vectors so that the ASR performed using the speech recognition model is dynamically adapted for the different speech characteristics of a detected speaker in an audio stream that is subject to transcription and/or is dynamically adapted for the environmental factors affecting the capture of that speaker's audio stream.

The DSRS and associated methods receive an audio stream with dialog for transcription from a particular audio capture device, detect the one or more speakers associated with the audio stream or the particular audio capture device, detect the particular audio capture device and/or the environment in which the particular audio capture device operates, select speaker-specific vectors, generated by the speaker adaptation model, for the detected speakers, select an environment-specific vector representing audio characteristics of the detected particular audio capture device and/or operating environment, generated by the environment adaptation model, apply the selected speaker-specific vectors and/or environment-specific vector to bias a speech recognition model, and generate a transcription of the dialog in the audio stream based on words detected by the biased speech recognition model. Biasing the speech recognition model includes adjusting vectors or embeddings of the speech recognition model representing different letter, letter combination, syllable, and/or word sounds according to the speech characteristics modeled by the selected speaker-specific vectors and according to the audio characteristics modeled by the selected environment-specific vector. Accordingly, the DSRS dynamically tunes speech recognition and transcription for different speakers based on speech characteristics of the different speakers, audio characteristics with which different devices capture the audio from the different speakers, and/or audio characteristics of different rooms or environments that affect the captured audio. In doing so, the technical solution implemented by the DSRS generates more accurate transcription of the dialog in each audio stream by dynamically adapting the speech recognition to account for the variances in each audio stream.

Rather than train different ASR services or speech recognition models for different speech characteristics (e.g., accents) and audio characteristics, the DSRS trains and defines a single speech recognition model with tunable vectors, and dynamically adjusts those tunable vectors with the speaker-specific vectors and/or the environment-specific vectors. Consequently, the dynamically adjusted single speech recognition model may transcribe different audio streams involving users with different speech characteristics and devices and/or environments with different audio characteristics with greater accuracy than if transcribing using a fixed or static speech recognition model.

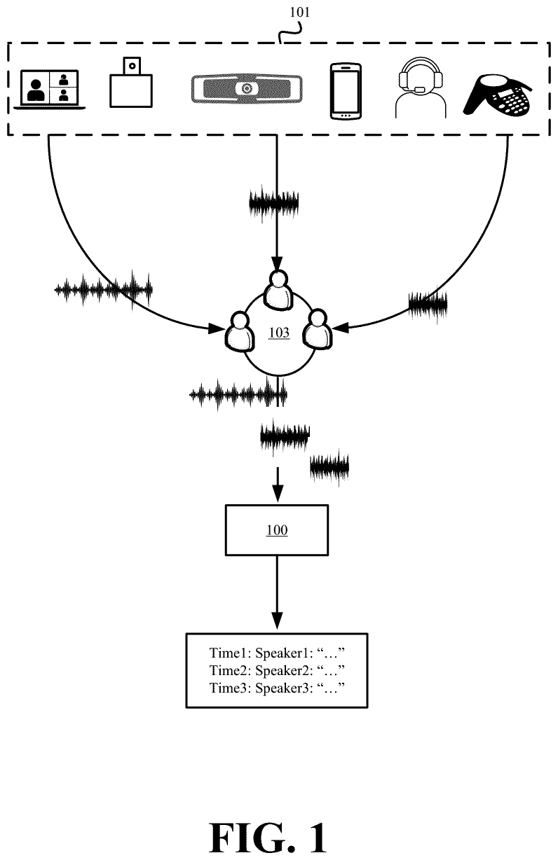

FIG. 1 illustrates an example architecture for performing the dynamic speech recognition and transcription using a speaker adaptation model and an environment adaptation model in accordance with some embodiments presented herein. The example architecture includes DSRS 100, audio capture devices 101, and conference service provider 103.

Audio capture devices 101 include the devices with which conference participants join and participate in a conference. Audio capture devices 101 include microphones for capturing audio and for encoding the audio in an audio stream that is sent to conference service provider 103. Each audio capture device 101 may have a different microphone that has different audio characteristics. For instance, some microphones perform noise cancellation, have different levels of gain, have single or multiple microphone arrays, have different levels of sensitivity for different frequencies, capture different frequencies with varying degrees of distortion, encode audio at different bitrates or quality levels, have near-field or far-field capabilities, are directional or omnidirectional, and/or have other capture characteristics that affect how the microphone captures and/or encodes sound.

In some embodiments, audio capture devices 101 are external microphones that are connected to a user device. The external microphones may include headsets or microphones that wirelessly connect or plug into a port of the user device, and that capture the audio differently than integrated microphones of the user device.

Also affecting the audio that is captured by audio capture devices 101 is the environment in which each audio capture device 101 is located. For instance, the audio captured by a particular microphone of audio capture device 101 may differ when the audio is captured in a small room that is isolated from outside or background noise and/or where the speaker is located close to the particular microphone versus when the audio is captured in a large room or outside environment with several external noises and/or where the speaker is far from the particular microphone. Different environments may be associated with different audio characteristics that affect how sound is captured by a microphone.

Audio capture devices 101 may further include speakers for playing back audio, cameras for capturing video, and displays for presenting images or video of other conference participants. Processor, memory, storage, network, and/or other hardware resources of audio capture devices 101 may be used to connect one or more users to a conference, encode and distribute audio and/or video streams from the users to the conference, and/or receive, decode, and playback audio and/or video from other users that are connected to the conference. Audio capture devices 101 may include desktop computers, laptop computers, tablet devices, smartphone devices, telephony devices, and/or other conferencing equipment that are integrated with or that are connected to audio capture devices 101 for audio and/or video capture and playback.

Conference service provider 103 establishes the connectivity between different audio capture devices 101, combines the audio and/or video streams from the connected audio capture devices 101, and distributes the combined streams for playback on the connected audio capture devices 101. For instance, audio capture devices 101 submit requests to join a particular conference that is identified with a unique Uniform Resource Locator (“URL”), name, or another identifier and that is hosted by conference service provider 103. The requests may include the names, identifiers, and/or login information for the one or more users using audio capture devices 101 to join the particular conference. Conference service provider 103 authorizes access to the particular conference based on stored or configured information about the users or audio capture devices 101 that are permitted to join the particular conference, created accounts that identify the users, and/or other identifying information that is sent with the requests (e.g., names, identifiers, login information, network addressing, port numbers, device signatures, etc.).

Conference service provider 103 may multiplex the streams from the different audio capture devices 101 that are connected to the same conference, and may create a unified stream that is provided to each audio capture device 101. The unified stream may synchronize the audio and/or video from the different contributing streams, enhance the stream quality, enforce access controls (e.g., who is allowed to speak, which streams are muted, etc.), and dynamically adjust stream quality based on the quality of the network connection to each audio capture device 101.

DSRS 100 receives the audio streams or a copy of the audio streams from each audio capture device 101 that is connected to a particular conference or from conference service provider 103. The audio streams include the audio that is captured by the microphone of each audio capture device 101.

DSRS 100 may also receive identifying information about the connected users or audio capture devices 101. For instance, DSRS 100 obtains session information that is associated with each stream or conference. The session information may include the Internet Protocol (“IP”) addresses, port numbers, and/or other device identifying information associated with each audio capture device 101 that is a connected endpoint to a conference. The session information may include the account information used by each audio capture device 101 to join a conference. The account information may include the email address, username, or other user identifying information (e.g., other user identifiers) that is provided by a user as part of the user joining the conference, that is used to authorize the user for access to the conference, or that identifies the user during the conference.

In an embodiment, the speech recognition model, trained by the DSRS 100, is a machine learning model implemented to transcribe different audio streams involving users with different speech characteristics and devices and/or environments with different audio characteristics. The speech recognition model may be a neural network, a linear regression model, a logistic regression model, a support vector machine, a decision tree, an ensemble model such as a random forest or a boosted decision tree, or any other model based on any other machine learning technique.

The speech recognition model may be trained using a corpus of audio streams containing a variety of speakers and a variety of environments. Training the speech recognition model involves providing audio streams in which different speakers speak the same or different words as inputs. The speech recognition model performs pattern recognition across the audio streams to determine commonality with which different speakers speak the same words or phrases and generates baseline vectors for detecting and transcribing those words or phrases. Specifically, the speech recognition model is trained to recognize spoken words and phrases based on generalized or normalized speech characteristics of a large group of individuals as opposed to being trained to recognize spoken words and phrases based on the speech characteristics of a single individual. In some embodiments, the training data may include audio streams of different speakers speaking with the same general accent (e.g., an American accent). In some other embodiments, the training data may include audio streams of different speakers speaking with different accents. Further details are described in the Machine Learning Models section herein.

In some embodiments, DSRS 100 may identify the speaker in an audio stream based in part on the session information and may use a trained speaker adaptation model to generate one or more speaker-specific vectors that represent the speech characteristics of the speaker or the differences between the speech characteristics of the speaker and the speech characteristics represented by the vectors of the speech recognition model. The speaker-specific vectors may be used as inputs for biasing the speech recognition performed by the speech recognition model for subsequent streams involving the identified speaker.

In an embodiment, the speaker adaptation model is a trained machine learning model configured to generate speaker-specific vectors or embeddings that describe or encode speech characteristics of a speaker. Specifically, the speaker adaptation model may detect deviations or differences between a speaker's speech characteristics and a baseline set of speech characteristics of audio samples that are used to train the speech recognition model used by DSRS 100 for speech recognition and transcription, and may generate the speaker-specific vectors based on the detected deviations or differences. The speaker adaptation model may be a linear regression model, a logistic regression model, a support vector machine, a decision tree, an ensemble model such a random forest or a boosted decision tree, or a neural network.

The speaker-specific vectors may capture specific or unique nuances in the speech characteristics of the speaker or speech characteristics that differ from those represented by the vectors of the speech recognition model. For instance, the speaker adaptation model may detect that the speaker speaks certain words with a unique emphasis (e.g., emphasizing different syllables), may pronounce certain letters or letter combinations with a specific accent or sound, may speak certain letters or letter combination with longer or shorter sounds (e.g., with a drawl), may speak with a distinct pitch, pacing, or tone, and/or other unique or different speech characteristics that cause the spoken words to sound differently or vary acoustically from the modeled sounds for the same words represented by the vectors of the speech recognition model.

For instance, the speech recognition model used by DSRS 100 for speech recognition and transcription may be trained to recognize English words based on American accents, and the speaker adaptation model may produce speaker-specific vectors that quantify or represent differences between a particular user's British accent and the American accents on which the speech recognition model is trained. The speaker-specific vectors may be used to adjust, bias, or otherwise change one or more vectors of the speech recognition model in order to account for the differences between the accents when performing the speech recognition on dialog that is spoken with the particular user's British accent.

The speaker adaptation model may be trained using a corpus of audio streams containing a variety of accents or speakers with different speech characteristics. The audio streams may be tagged or labelled with accent identifiers or other identifiers that identify the unique speech characteristics represented by the audio streams. Further details are described below.

The speaker-specific vectors generated for each particular speaker are associated with a unique speaker identifier so that they may be retrieved and used to bias the speech recognition model and/or the speech transcription when the input audio stream contains speech of the particular speaker. The speaker-specific vectors may be stored in a database, a volatile memory, or a non-volatile storage of DSRS 100 for on-demand access when transcribing audio streams of different speakers.

In some embodiments, DSRS 100 may identify the audio capture device used to generate an audio stream based in part on the session information and may use an environment adaptation model to generate one or more environment-specific vectors that represent audio characteristics of the detected audio capture device generating the audio stream and/or characteristics of the environment in which the audio is being captured. The environment-specific vectors may be used as input to bias the speech recognition performed for subsequent streams involving the same audio capture device or the same environment.

In an embodiment, the environment adaptation model is a trained machine learning model configured to generate environment-specific vectors or embeddings that describe or encode the audio characteristics of an audio capture device and/or a room, setting, or environment in which the audio is captured. DSRS 100 uses the environment-specific vectors to perform a second biasing of the speech recognition model and to further customize the speech recognition and transcription performed with the speech recognition model.

The environment-specific vectors bias the speech recognition so that the recognition of words is unaffected by differences or variances in the audio capture and audio encoding. For instance, two different audio capture devices 101 may record and encode the same word spoken by the same speaker differently because of differences in the microphone properties and/or environment acoustics in which each audio capture device operates. The unbiased or unadjusted speech recognition model may correctly detect the word in the first audio recording or first stream, and may incorrectly detect the word in the second audio recording or second stream because of the differences in how the audio for the spoken word is recorded and/or encoded. The environment-specific vectors bias the speech recognition model to account for the differences when performing the speech recognition. Biasing the speech recognition model may include adjusting the audio characteristic vectors to effectively normalize the audio and/or remove or adjust for the modeled differences in the audio characteristics.

In some embodiments, the environment-specific vectors represent specific or unique affects that different audio capture devices impart on the audio stream when capturing sounds or encoding the sounds to an audio stream. For instance, the environment-specific vectors may represent different gain levels, frequency sensitivity, noise filtering algorithms (e.g., noise cancellation), encoding algorithms, and/or other properties that may affect the captured sound or encoding of the captured sound. Consequently, the same sound captured by different audio capture devices may be represented differently in the audio streams created by the different audio capture devices, and the environment-specific vectors identify the differences or the different affects that different audio capture devices have on the captured sound.

In some embodiments, the environment-specific vectors represent acoustic properties of the environment or the effects that the acoustic properties of the environment have on the captured sound. For instance, the environment-specific vectors may identify that a certain room or environment introduces an echo, adds a certain amount of reverberation, or is typically subject to a particular background noise. The environment adaptation model may be a linear regression model, a logistic regression model, a support vector machine, a decision tree, an ensemble model such a random forest or a boosted decision tree, or a neural network.

The environment adaptation model may be trained using a corpus of audio streams that are captured by different audio capture devices and/or in different environments (e.g., conference rooms of an office). The audio streams may be tagged or labelled with audio capture device identifiers and/or environment identifiers to identify the specific audio capture device that was used to capture the audio stream or the environment in which the audio stream was captured. Further details are described below. The environment-specific vectors are associated with one or more unique environment identifiers that identify the audio capture device and/or environment represented by each environment-specific vector. These environment identifiers are stored with the environment-specific vectors so that the correct environment-specific vector for a particular audio capture device or a particular environment may be applied when transcribing an audio stream that was captured with that particular audio capture device in that particular environment. The environment-specific vectors may be stored in a database, a volatile memory, or a non-volatile storage of DSRS 100.

DSRS 100 executes on one or more devices or machines that are part of or separate from the devices or machines of conference service provider 103. In some embodiments, DSRS 100 is a centralized system that transcribes dialog for different conferences hosted by conference service provider 103. In some other embodiments, DSRS 100 runs on each audio capture device 101 and performs localized transcription of the dialog in the captured and received audio streams.

In some embodiments, DSRS 100 executes independent of conference service provider 103. In some such embodiments, DSRS 100 may transcribe dialog from a recorded conference or one or more recorded audio streams. The recorded conference may include the recorded audio from multiple speakers in a conference and supplemental information (e.g., metadata) for the audio capture devices 101 that were connected to that conference or the identifying information for the users that joined the conference.

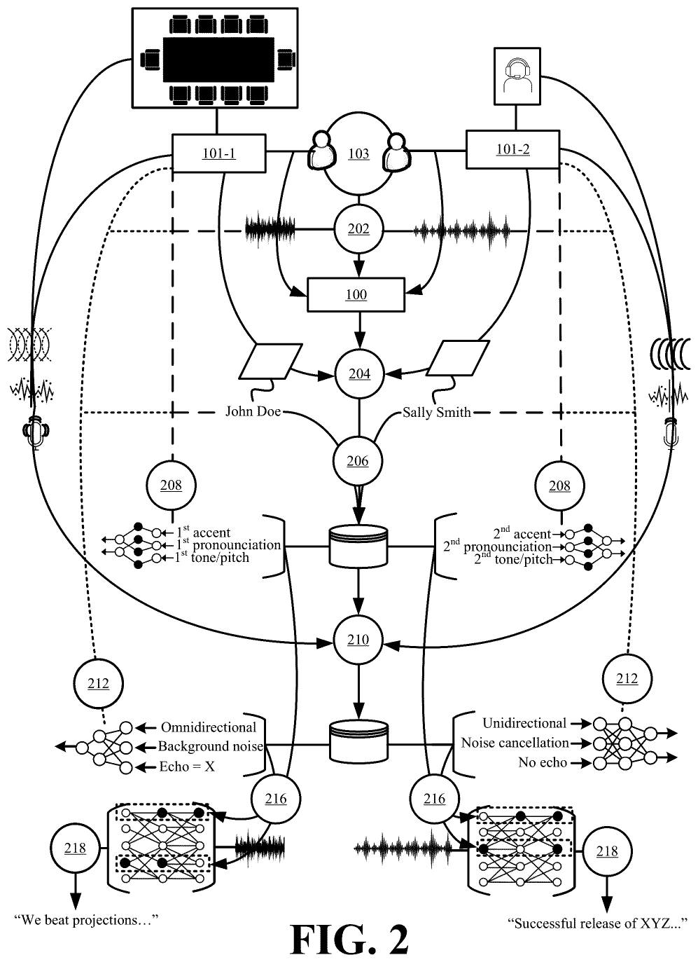

FIG. 2 illustrates an example of dynamically customizing speech recognition for different speech characteristics of different users and for different audio characteristics of different audio capture devices 101 and environments based on output from the speaker adaptation model and/or the environmental adaptation model in accordance with some embodiments presented herein. DSRS 100 is configured and activated to perform speech-to-text conversion or to transcribe a conference involving multiple participants. DSRS 100 receives (at 202) a first audio stream from first audio capture device 101-1 and a second audio stream from second audio capture device 101-2. First audio capture device 101-1 and second audio capture device 101-2 are connected to the conference over a data network.

The first audio stream and the second audio stream encode the audio that is captured by the respective microphones of first audio capture device 101-1 and second audio capture device 101-2. In some embodiments, the first audio stream and the second audio stream may be multiplexed or combined into a single composite audio stream by conference service provider 103. For instance, first audio capture device 101-1 transmits the first audio stream to conference service provider 103, second audio capture device 101-2 transmits the second audio stream to conference service provider 103, conference service provider 103 generates a unified conference stream from the first and second audio streams, and DSRS 100 receives (at 202) the unified conference stream from conference service provider 103.

DSRS 100 identifies (at 204) a first user that is associated with the first audio stream and a second user that is associated with the second audio stream. The user identification (at 204) may be based on identifying information that accompanies each of the audio streams, login or conference registration information received from first audio capture device 101-1 and second audio capture device 101-2, or voice signatures of the first user detected in the first audio stream and of the second user detected in the second audio stream.

The identifying information may include a name, email address, or another identifier that the first user enters prior to joining the conference and that first audio capture device 101-1 transmits along with the first audio stream, and a name, email address, or another identifier that the second user enters prior to joining to the conference and that second audio capture device 101-2 transmits along with the second audio stream. The identifying information may uniquely identify each user. For instance, the first user name in combination with a device identifier of first audio capture device 101-1 (e.g., network address, session identifier, unique identifier, user agent, and/or device fingerprint) may uniquely identify the first user from other users that may have the same name.

The login or conference registration information may include a username and password combination or other identifiers with which the first user and the second user gain access to the conference. In some embodiments, the login or conference registration information may access different user accounts or profiles that are stored at conference service provider 103. The user accounts or profiles may contain the identifying information for the associated user.

The voice signatures may uniquely identify differences in the voices or voice characteristics of each user. The voice signatures may measure different qualities of each user's voice including their pitch, tone, and/or frequency. DSRS 100 may analyze a snippet of audio from each of the first audio stream and the second audio stream to determine the voice characteristics of each speaker, and may identify the speaker by matching the determined voice characteristics to a voice signature of that identified speaker.

DSRS 100 retrieves (at 206) a first set of speaker-specific vectors that was generated by the speaker adaptation model for the first user based on a prior identification of the first user in one or more previous conferences and a prior modeling of the first user's speech characteristics in the one or more previous conferences. The first set of speaker-specific vectors represents the first user's speech characteristics in those one or more previous conferences. DSRS 100 also retrieves (at 206) a second set of speaker-specific vectors that was generated by the speaker adaptation model for the second user based on a prior identification of the second user in one or more previous conferences and a prior modeling of the second user's speech characteristics in the one or more previous conferences. In some embodiments, each speaker-specific vector is linked to a user identifier or a user account, and DSRS 100 associates (at 208) the correct set of speaker-specific vectors to each speaker by matching the identifying information that is identified for each audio stream to the user identifier or user account that is linked to the speaker-specific vectors created for that user.

The first set of speaker-specific vectors is defined or encoded to represent nuances or distinctive speech characteristics of the first user, and the second set of speaker-specific vectors is defined or encoded to represent nuances or distinctive speech characteristics of the second user. For instance, the vectors may include a connected set of synapses that define the speaker's accent by representing the manner with which the speaker pronounces specific letters, phrases, or sounds, may model distinctive features of the speaker's voice based on tone, pitch, intensity, and/or frequency, and/or may model how the speaker pronounces different letters, letter combinations, syllables, or words.

In some embodiments, the speaker-specific vectors are defined based on differences between the user's speech characteristics and baseline speech characteristics against which a speech recognition model used by DSRS 100 is trained. For instance, the speech recognition model is trained to detect a particular word as spoken with speech characteristics of a first accent, and the first set of speaker-specific vectors contains one or more synapses that represent differences between the speech characteristics of the first user and the speech characteristics of the first accent against which the speech recognition model is trained. More specifically, the synapses of the first set of speaker-specific vectors may specify that the first user shifts emphasis from a first syllable to a second syllable of the particular word or pronounces a specific letter combination in the particular word differently than speakers having the speech characteristics of the first accent.

In some embodiments, DSRS 100 may detect multiple speakers speaking in the same audio stream. For instance, multiple users may be in the same conference room and may use the same audio capture device 101 to participate in a conference. In some such embodiments, DSRS 100 may associate (at 208) different sets of speaker-specific vectors to that same audio stream with voice signatures, tags, or other identifiers that link each set of speaker-specific vectors to the correct speaker or user on that audio stream.

DSRS 100 determines (at 210) audio characteristics of first audio capture device 101-1 and second audio capture device 101-2 and/or audio characteristics of different rooms or environments in which first audio capture device 101-1 and second audio capture device 101-2 operate. The audio characteristics correspond to different measures or properties associated with the different microphones that are used to generate the first audio stream and the second audio stream. For instance, the audio characteristics correspond to certain frequencies that are canceled because of noise cancellation or audio encoding/compression, gain levels of the microphone, frequency range of the microphone, and capturing and/or encoding capabilities of the microphones. The audio characteristics also correspond to properties of the room or environment in which the speakers are located. In such cases, the audio characteristics may measure the amount of echo, background noise, speaker distance, an/or other effects that the environmental factors impart onto the audio streams.

In some embodiments, DSRS 100 determines (at 210) the audio characteristics based on device identifiers of first audio capture device 101-1 and second audio capture device 101-2. The device identifier may specify the make and model of each audio capture device 101, and may be used to retrieve or lookup the audio characteristics of each audio capture device 101. In some embodiments, the device identifier corresponds to the user agent, a model number, or other unique device signature. The device identifiers may be obtained from the headers or metadata of the audio stream packets or may be provided by each audio capture device 101 upon the audio capture device 101 registering or joining the conference.

In some embodiments, DSRS 100 determines (at 210) the audio characteristics from analyzing an audio sample from each of the first audio stream and the second audio stream. In some such embodiments, the audio analysis measures properties of the encoded audio and/or of the microphone or device used to capture the audio. From the audio analysis, DSRS 100 may determine how the audio signal is changed by the device microphone and/or encoding of the captured sound. The audio analysis may also reveal various acoustic properties of the operating room or environment that affect the received (at 202) audio stream.

In some embodiments, DSRS 100 determines (at 210) the audio characteristics based on location data associated with each audio capture device 101. For instance, the Internet Protocol (“IP”) address of first audio capture device 101-1 may be mapped to a first conference room or a first location with a first set of audio characteristics, and the IP address of second audio capture device 101-2 may be mapped to a second conference room or a second location with a second set of audio characteristics. Alternatively, audio capture devices 101 may provide Global Positioning System (“GPS”) or other location data that DSRS 100 maps to rooms or environments with different acoustic properties or effects on the captured audio.

DSRS 100 associates (at 212) a first set of environment-specific vectors, generated by the environment adaptation model, to the first audio stream and a second set of environment-specific vectors, generated by the environment adaptation model, to the second audio stream based on the determined (at 210) audio characteristics. Each of the different environment-specific vectors accounts for changes that are made to the audio stream because of differences by which different microphones capture sound, differences in the encoding of the captured sound, and/or the acoustic properties of the room or environment in which the sound is captured.

DSRS 100 uses (at 216) the associated (at 208) speaker-specific vectors and the associated (at 212) environment-specific vectors to bias or adjust the speech recognition model and to customize the speech recognition and transcription that is performed by the speech recognition model on each of the first audio stream and the second audio stream or the dialog of the identified (at 204) first user and the dialog of the identified (at 204) second user. Specifically, DSRS 100 uses (at 216) the associated (at 208) speaker-specific vectors and the associated (at 212) environment-specific vectors to bias or adjust the speech recognition model and to customize the speech recognition and transcription for the different speech characteristics of the respective speakers and the different audio characteristics associated with first audio capture device 101-1, second audio capture device 101-2, and/or the different environments in which each audio capture device is located. Using (at 216) the associated (at 208 and 212) vectors includes performing a first tuning or customization of the speech recognition model based on the first set of speaker-specific vectors and first set of environment-specific vectors prior to recognizing and transcribing the dialog in the first audio stream, and performing a second tuning or customization of the speech recognition model based on the second set of speaker-specific vectors and the second set of environment-specific vectors prior to recognizing and transcribing the dialog in the second audio stream. Specifically, using (at 216) the associated (at 208 and 212) speaker-specific vectors and environment-specific vectors includes dynamically adjusting the speech-to-text vectors of the speech recognition model to account for the unique or different speech characteristics of the first user represented in the first set of speaker-specific vectors and to further account for the audio characteristics of first audio capture device 101-1 and the first environment in the first set of environment-specific vectors when transcribing the first audio stream. Consequently, the adjusted speech recognition model better differentiates words spoken by the first user by mitigating or compensating for the unique or different speech characteristic of the first user and the specific audio characteristics introduced into the first audio stream by first audio capture device 101-1 and the first environment. Using (at 216) the associated (at 208 and 212) speaker-specific vectors and environment-specific vectors further includes dynamically readjusting the speech-to-text vectors of the speech recognition model to account for the unique or different speech characteristics of the second user represented in the second set of speaker-specific vectors and to further account for the audio characteristics of second audio capture device 101-2 and the second environment in the second set of environment-specific vectors when transcribing the second audio stream. Consequently, the speech recognition model is dynamically adjusted to better differentiate words spoken by the second user by mitigating or compensation for the unique or different speech characteristic of the second user and the specific audio characteristics introduced into the second audio stream by second audio capture device 101-2 and the second environment.

As a specific example, the speech recognition model may be trained to recognize a particular word with an emphasis on the first syllable of the particular word and with a first pronunciation of a particular long vowel sound. The speaker adaptation model may produce a speaker-specific vector, which when used to dynamically tune the speech recognition model, causes the speech recognition model to transcribe the audio from the first audio stream so that the particular word is recognized with the emphasis on the second syllable instead of the first syllable and with a second pronunciation of the particular long vowel sound. In other words, the speaker-specific vector modifies the speech recognition, performed by the speech recognition model, to account for the variances between the first user's speech characteristics and the speech characteristics that were used to train the speech recognition.

Similarly, DSRS 100 uses (at 216) the environment-specific vectors, generated by the environment adaptation model, to adjust speech recognition model for variances created in the first audio stream by the qualities or properties of the first audio capture device 101-1 microphone and the operating environment. In some embodiments, the environment-specific vectors may identify sound frequencies that correspond to room noise or background noise and that can be filtered out from the speech recognition, and/or may identify changes to the frequencies of the speaker dialog caused by the first audio capture device 101-1 microphone that the speech recognition model may compensate for in order to normalize the dialog to frequencies that the speech recognition model was trained to recognize.

DSRS 100 transcribes (at 218) the dialog in the first audio stream according to a first biasing of the speech recognition model with the first set of speaker-specific vectors and/or the first set of environment-specific vectors that are associated (at 208 and 212) to the first user, first audio capture device 101-1, and/or the first audio stream, and transcribes (at 218) the dialog in the second audio stream according to a different second biasing of the speech recognition model with the second set of speech-specific vectors and/or the second set of environment-specific vectors that are associated (at 208 and 212) to the second user, second audio capture device 101-1, and/or the second audio stream. The biasing improves the speech detection accuracy relative to the different speech characteristics of the different speakers (e.g., the first user and the second user) identified in the different audio streams, the different audio characteristics with which first audio capture device 101-1 and second audio capture device 101-2 capture and encode the first audio stream and the second audio stream respectively, and the different audio characteristics from the different operating environments that affect or are mixed in with the dialog.

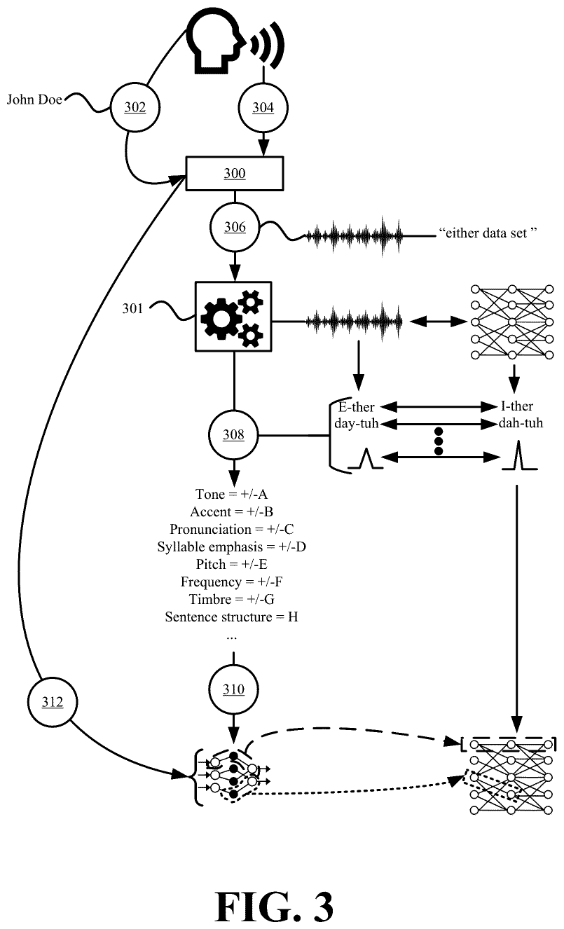

FIG. 3 illustrates an example of the speaker adaptation model defining speaker-specific vectors based on the unique speech characteristics of a particular speaker in accordance with some embodiments presented herein. Speaker adaptation model 300 identifies (at 302) the particular speaker based on login information provided by the particular speaker, a unique voice signature of the particular speaker, session information provided when the particular speaker joins a conference, and/or other identifiers that uniquely identify the particular speaker.

Speaker adaptation model 300 obtains (at 304) an audio snippet or sound sample containing dialog from the particular speaker. In some embodiments, Speaker adaptation model 300 obtains (at 304) the sound sample from one or more conferences or communication sessions involving the particular speaker. In some other embodiments, Speaker adaptation model 300 obtains (at 304) the sound sample by requesting that the particular speaker read one or more sentences prior to joining a conference when no speaker adaptation model is defined for the particular speaker.

Speaker adaptation model 300 may use (at 306) linguistic parser 301 or speech characteristic detection neural network 301 to measure or determine (at 308) different speech characteristics of the particular speaker by analyzing the sound sample. For instance, linguistic parser 301 measures the tone, pitch, and frequencies of the particular speaker's voice, and analyzes the pronunciation of different spoken words to quantify the particular speaker's accent. The particular speaker's accent may be quantified in terms of different syllables that the particular speaker emphasizes when speaking certain words, different pronunciations of letter combinations, different letter sounds, and other such voice characteristics.

In some embodiments, linguistic parser 301 may determine (at 308) the speech characteristics of the particular speaker based on differences, variances, or unique features between the speech characteristics of the particular speaker and the speech characteristics of the audio samples that were used to train the speech recognition model. For instance, the speech recognition model is trained with audio samples of different speakers speaking the same set of words. The training produces vectors that represent common voice characteristics for accurately differentiating and recognizing each of the spoken words (e.g., each word from the same set of words spoken in the audio samples). Linguistic parser 301 may compare the speech characteristics with which the particular speaker speaks a particular word to the common speech characteristics that were identified to accurately represent the particular word in the audio samples used to trained the speech recognition model and the vector for recognizing the particular word.

Speaker adaptation model 300 defines (at 310) a set of speaker-specific vectors based on the determined (at 308) speech characteristics of the particular speaker or the determined (at 308) differences and/or unique features between the particular speaker's speech characteristics and the speech characteristics that were used in training the speech recognition model. In some embodiments, defining (at 310) the set of speaker-specific vectors includes generating synapses or embeddings that represent the determined (at 308) differences in tone, pitch, frequency, intensity, accent, pronunciation, letter or syllable emphasis, and/or other speech characteristics in the voice of the particular speaker and the voices used to train the speech recognition model, and/or synapses or embeddings that may bias, adjust, or otherwise change vectors representing similar speech characteristics in the speech recognition model to account for the determined (at 308) differences. In some embodiments, defining (at 310) the set of speaker-specific vectors includes generating synapses or embeddings that represent the determined (at 308) unique features in tone, pitch, frequency, intensity, accent, pronunciation, letter or syllable emphasis, and/or other speech characteristics of the particular speaker that differentiate the particular speaker's voice from the voices used to train the speech recognition model.

Speaker adaptation model 300 associates (at 312) the set of speaker-specific vectors that is defined for the speech characteristics of the particular speaker to one or more identifiers that uniquely identify (at 302) the particular speaker. For instance, speaker adaptation model 300 may associate (at 312) the defined (at 310) set of speaker-specific vectors to a unique identifier or an account or profile of the particular speaker that is accessed via login credentials of the particular speaker. The unique identifier may correspond to the particular speaker name, email address, login information, or other values that uniquely identify the particular speaker or is uniquely associated with the particular speaker. In some embodiments, the account or profile of the particular speaker is accessed when the particular speaker provides login information or the unique identifier to join a conference. DSRS 100 may receive the login information or the unique identifier, access the account or profile, and retrieve the speaker-specific vectors that is defined for or linked to that particular speaker when subsequently transcribing a new conference or audio stream that includes speech from the particular speaker.

In some embodiments, the set of speaker-specific vectors may be downloaded to and stored on the user device (e.g., audio capture device 101) or an application that the particular speaker uses or accesses to join different conferences. The application may provide the set of speaker-specific vectors to DSRS 100 upon joining a conference, or DSRS 100 may run locally on the user device and transcribe the audio of the particular speaker on that user device by customizing the speech recognition model with the set of speaker-specific vectors. The transcription may be shared with other audio capture devices 101 participating in the same conference or may be provided to conference service provider 103 for aggregation with transcriptions from other audio capture devices 101 and for distribution to other audio capture devices 101.

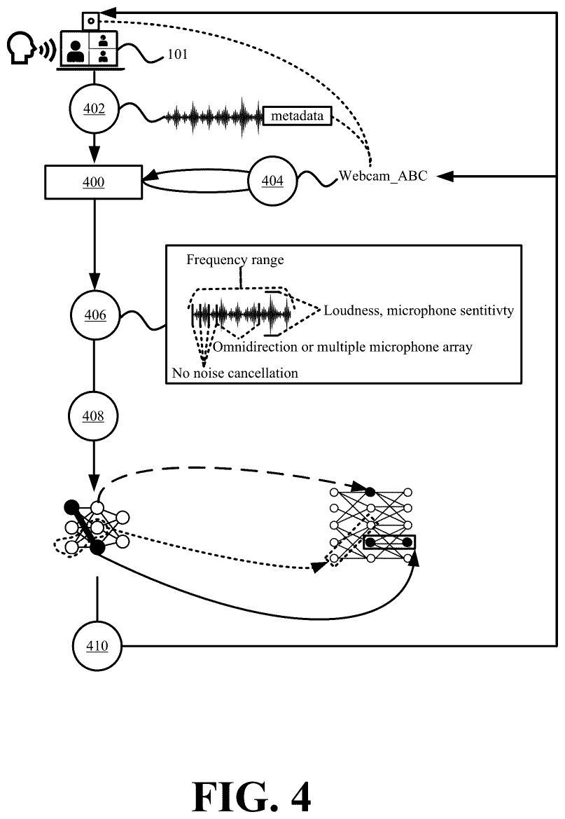

FIG. 4 illustrates an example of the environment adaptation model defining environment-specific vectors based on the audio characteristics of an audio capture device 101 in accordance with some embodiments presented herein. Environment adaptation model 400 receives (at 402) an audio stream that is generated by audio capture device 101. The audio stream includes dialog that is recorded by one or more microphones or input devices of audio capture device 101 and that is encoded at a particular bitrate, at a frequency range, or using a particular encoding algorithm.

Environment adaptation model 400 determines (at 404) the input device that generates the received (at 402) audio stream. Audio capture device 101 may provide an identifier for the input device in association with the audio stream. For instance, the identifier may be included in the metadata, packet headers, or other data accompanying the audio stream. The identifier may correspond to the name, make and model, or other value that uniquely identifies the input device. The input device identifier may identify audio capture device 101 when an integrated microphone of audio capture device 101 is used, or may identify an external microphone or peripheral that is connected to audio capture device 101 when audio capture device 101 does not have an integrated microphone or when the external peripheral is used to record audio in place of the integrated microphone. The external peripheral may include a headset or external microphone that is connected to audio capture device 101.

Environment adaptation model 400 may compare (at 406) the encoded audio signal generated by that audio capture device 101 to audio signals that are used to train the speech recognition model or to a baseline audio signal, and may measure differences in the audio characteristics between the compared audio signals. Alternatively, environment adaptation model 400 may analyze (at 406) the encoded audio signal in isolation, and may determine the audio characteristics based on the encoded audio signal analysis.

Different microphones may have different audio characteristics. The audio characteristics may correspond to the sensitivity of the microphone (e.g., near-field or far-field sensitivity), directionality of the microphone, the frequency range that is captured by the microphone, the accuracy with which the sound is recorded or encoded, processing that may be applied to the audio during capture or encoding, and/or features of the microphone that affect the audio capture. For instance, some microphones perform noise cancellation that removes certain frequencies or frequency ranges from the captured or encoded audio, some microphones are unidirectional and more accurately capture sound coming from directly in front of the microphone than from behind or around the microphone, some microphones are omnidirectional and accurately capture sound from all directions, some microphones make voices sound hollow, and/or some microphones encode audio at a lower bitrate that changes the tone or range of the speaker's voice.

Environment adaptation model 400 defines (at 408) one or more environment-specific vectors based on the detected audio characteristics. Specifically, environment adaptation model 400 may define (at 408) environment-specific vectors with synapses or embeddings that specify variations between different audio characteristics in the audio signal generated by the identified input device and normalized or baseline audio characteristics for the audio samples used to train the speech recognition model used by DSRS 100 for speech recognition and transcription.

Environment adaptation model 400 associates (at 410) the defined (at 408) environment-specific vectors to the input device that generates the audio stream from which the environment-specific vectors are defined. Specifically, environment adaptation model 400 associates (at 410) the environment-specific vectors to the determined (at 404) identifier for the input device. When the same input device identifier is detected in a subsequent conference, DSRS 100 may bias the speech recognition model with the correct environment-specific vectors so that the speech recognition is performed by normalizing, eliminating, or otherwise accounting for the differences in the audio characteristics of the audio stream that is produced by the identified input device and audio characteristics of the audio samples used to train the speech recognition model.

Environment adaptation model 400 may also define environment-specific vectors based on the audio characteristics of a room or environment that may affect the audio that is captured by audio capture devices 101 or an associated input device. For instance, the environment may introduce an amount of echo or reverberation to the voice of a speaker. The environment may also introduce background noise or change the distance between speakers and the microphone. These and other audio characteristics of the room or environment may affect accuracy of the speech recognition by altering the audio stream. Accordingly, environment adaptation model 400 may define the environment-specific vectors to represent or account for the room or environment audio characteristics.

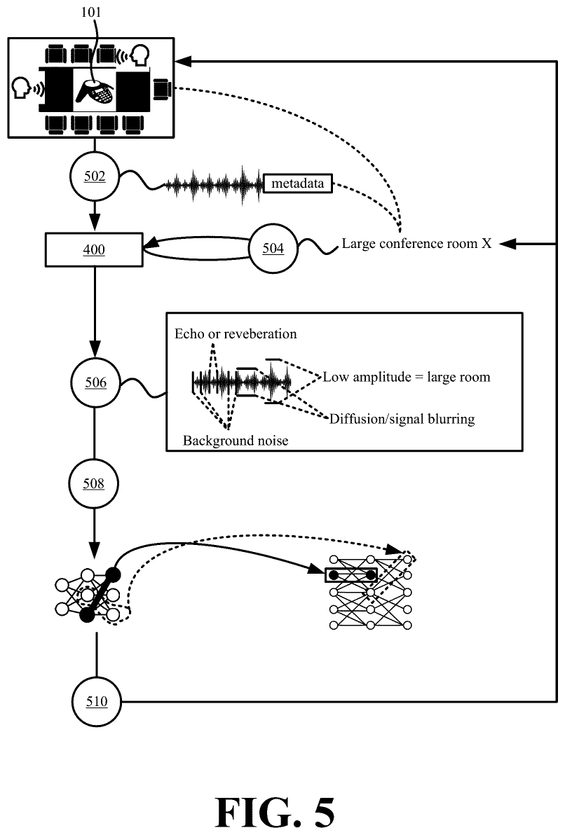

FIG. 5 illustrates an example of defining environment-specific vectors based on the audio characteristics of a room in accordance with some embodiments presented herein. Environment adaptation model 400 receives (at 502) an audio stream from audio capture device 101 located in the room.

Environment adaptation model 400 identifies (at 504) the room. The room identification (at 502) may be based on geolocation data provided by audio capture device 101, network addressing of audio capture device 101 that is mapped or linked to the room, and/or a room identifier. The room identifier may correspond to a name assigned to the room. Environment adaptation model 400 may receive the room identifier in messaging from audio capture device 101 or in identifying information for a conference that audio capture device 101 joins. For instance, a conference invitation may specify the room identifier and may include audio capture device 101 as an authorized device that may join the conference. The geolocation data, network addressing, and/or room identifier may be provided as metadata or in the header of the audio stream packets.

Environment adaptation model 400 analyzes (at 506) the received (at 502) audio stream to determine the audio characteristics of the room. The room audio characteristics correspond to a set of environmental factors that may impart sound, distort, or otherwise affect the dialog in the audio stream. For instance, environment adaptation model 400 may measure the amount of echo or reverberation that is detected in the audio stream. Environment adaptation model 400 may also compare the received (at 502) audio stream to audio characteristics of a baseline audio stream or audio streams against which the speech recognition model is trained to detect differences in the room audio characteristics. For instance, environment adaptation model 400 may detect a consistent low frequency pattern that is consistent with background noise and that is present in the received (at 502) audio stream but is not present in the audio stream used to train the speech recognition model. The background noise may degrade the speech recognition accuracy by interfering with certain frequencies that are used in differentiating different letter sounds.

Environment adaptation model 400 defines (at 508) one or more environment-specific vectors to represent the room audio characteristics or the differences between the audio characteristics of the room and the baseline audio characteristics against which the speech recognition model is trained. For instance, the vectors may include synapses or embeddings that represent an amount of echo or reverberation that the identified (at 504) room or environment introduces or adds to an audio stream captured in that room or environment, an amount by which the dialog is diffused or muffled because of the room size, and/or different affects that other environmental factors have on the audio recorded in that room or environment. Specifically, each environment-specific vector corresponds or maps to a vector or one or more vector coefficients of the speech recognition model, and specifies an adjustment to that vector or the one or more vector coefficients that compensates for the represented difference in audio characteristics.

Environment adaptation model 400 associates (at 510) the defined (at 508) environment-specific vectors to the room or room identifier. Accordingly, when the same room is detected as the operating environment for an audio stream for speech recognition and transcription, DSRS 100 may bias the speech recognition model with the correct environment-specific vectors so that the audio stream is normalized or the different audio characteristics introduced by that room are eliminated or otherwise accounted for when performing the speech recognition and transcription.

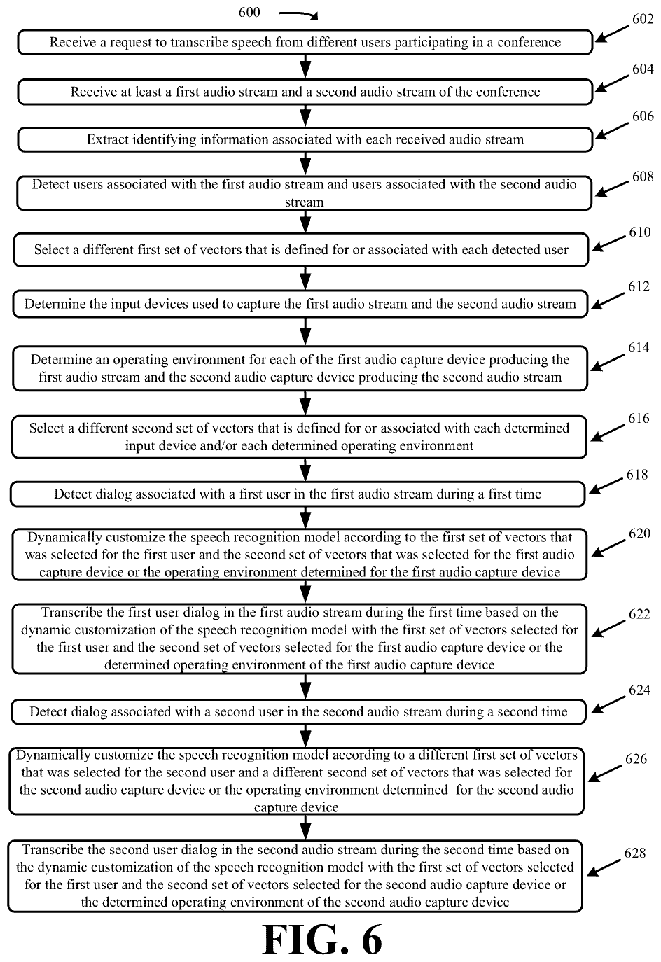

FIG. 6 presents a process 600 for dynamically customizing the speech recognition and transcription for different audio streams of a conference using different speaker-specific vectors and environment-specific vectors in accordance with some embodiments presented herein. Process 600 is implemented by DSRS 100 for a conference hosted by conference service provider 103 involving at least first audio capture device 101-1 and second audio capture device 101-2.

Process 600 includes receiving (at 602) a request to transcribe speech from different users participating in a conference, conversation, or otherwise exchanging dialog (e.g., via a presentation, an interview, a lecture, etc.). The request may be issued by one or more of the participants or by conference service provider 103. The request may be issued with the identifier of a conference that has yet to commence, an ongoing conference, or a completed conference that has been recorded. For instance, a user may select a button or function that performs the transcription or may invoke the transcription functionality when defining and/or sending the conference invitation to the participants. In some embodiments, DSRS 100 may be configured to automatically perform the transcription for conferences or audio streams hosted by conference service provider 103.

Process 600 includes receiving (at 604) at least a first audio stream and a second audio stream of the conference or conversation. DSRS 100 may receive (at 604) the first audio stream directly from first audio capture device 101-1 and the second audio stream directly from second audio capture device 101-2. Alternatively, DSRS 100 may receive (at 604) the audio streams from conference service provider 103.

Process 600 includes extracting (at 606) identifying information associated with each received (at 604) audio stream. The identifying information may be included in and extracted from the audio stream metadata, headers of the packets encoding the audio streams, supplemental packets sent with the packets encoding the audio, and/or data provided for the conference by conference service provider 103. The identifying information may include identifying information for the participants, first audio capture device 101-1, second audio capture device 101-2, the conference location, the audio stream encoding, etc.

Process 600 includes detecting (at 608) one or more users associated with the first audio stream and one or more users associated with the second audio stream. DSRS 100 may detect (at 608) the users based on the received (at 606) identifying information. For instance, the identifying information may include identifiers of the users associated with each audio stream. The identifiers may correspond to names or other values that directly identify the users. The identifiers may also indirectly identify the users. For instance, the identifying information may include an email address or login information provided by first audio capture device 101-1 and second capture device 101-2 when joining the conference and that DSRS 100 uses to access user accounts. The user accounts may store the user identifying information.

Since multiple users may connect to the conference via a single audio capture device 101 or a single audio stream, DSRS 100 may also detect (at 608) the users by matching audio snippets that are sampled from the first audio stream and the second audio stream to voice signatures of the detected users. For instance, DSRS 100 may differentiate and separately detect a first user from a second user speaking in the first audio stream based on a first pitch, tone, accent, and other voice characteristics of the first user matching a stored first voice signature with a first user identifier for the first user and a second pitch, tone, accent, and other voice characteristics of the second user matching a second voice signature with a second user identifier for the second user.

Process 600 includes selecting (at 610) a different first set of vectors (e.g., a first set of speaker-specific vectors) that is defined for or associated with each detected (at 608) user. Each first set of vectors may include speaker-specific vectors that represent unique or differentiating speech characteristics for a different detected (at 608) user. In some embodiments, each speaker-specific vector of the selected (at 610) first set of vectors quantifies or represents a difference between a particular speech characteristic of a detected (at 608) user and a baseline measure for that particular speech characteristic or a unique speech characteristic of the detected (at 608) user relative to the speech characteristics found within the baseline measure. The baseline measure may include a value for the particular speech characteristic that was used to train the speech recognition model used by DSRS 100 for speech recognition and transcription, and/or is the value for the particular speech characteristic that the speech recognition model uses to match certain sounds to word or textual equivalents. For instance, the particular speech characteristic may represent the sound by which the speech recognition model detects certain letters, letter combinations, syllables, or words, and may be specific to a particular accent or generalized to detect the same letters, letter combinations, syllables, or words spoken with different accents, pronunciations, and/or other variances. A speaker-specific vector in the first set of vectors selected (at 610) for a particular user may represent the difference in how that particular user speaks that sound versus the sound that the speech recognition model uses to recognize those certain letters, letter combinations, syllables, or words, or may represent the unique features with which the particular user speaks certain letters, letter combinations, syllables, or words.

Process 600 includes determining (at 612) the input devices that are used to capture the first audio stream and the second audio stream. The input device determination (at 612) may be based on the extracted (at 606) identifying information. The identifying information may include the user agent, unique device signature, input device identifier, network address, and/or other identifiers that may be mapped to an identification of the input device. For instance, prior to first audio capture device 101-1 joining the conference, the user may be presented with a user interface and a detected list of input devices for capturing the audio. The detected list of input devices may include an integrated microphone of first audio capture device 101-1 and/or one or more external or peripheral devices that are connected to first audio capture device 101-1 and that may be used to capture the audio instead of the integrated microphone. The identifier (e.g., name, make and model, etc.) for the selected input device may be included as part of the identifying information. In some embodiments, DSRS 100 may query first audio capture device 101-1 and second audio capture device 101-2 for the input device identifiers.

Process 600 includes determining (at 614) an operating environment for each of first audio capture device 101-1 and second audio capture device 101-2. The operating environment may correspond to a physical location such as a specific room or office, an outdoor setting, or a generalized setting (e.g., large room, small room, outdoors, etc.).

DSRS 100 may determine (at 614) the operating environment from the extracted (at 606) identifying information. For instance, the identifying information may be the IP address or geolocation information of first audio capture device 101-1, and DSRS 100 may map that IP address or geolocation information to a specific conference room.

DSRS 100 may also analyze the audio streams to determine (at 614) the operating environment. If a speaker's voice is distant, small, captured with the same intensity as other speaker voices, or captured with a first echo or reverberation, then DSRS 100 may determine (at 614) the operating environment to be a large conference room. If there is a large amount of background noise, then DSRS 100 may determine (at 614) the operating environment to be outdoors or in an open setting (e.g., a coffee shop). If the speaker's voice is loud, distinct from other sounds, and captured with a second echo or reverberation, then DSRS 100 may determine (at 614) the operating environment to be small office or room.

Process 600 includes selecting (at 616) a different second set of vectors (e.g., a second set of environment-specific vectors) that is defined for or associated with each determined (at 612) input device and/or each determined (at 614) operating environment. Each second set of vectors may include environment-specific vectors that represent defined or differentiating audio characteristics for a different determined (at 612) input device or for a different determined (at 614) operating environment. In some embodiments, each environment-specific vector quantifies or represents a difference between a particular capture characteristic of a determined (at 612) input device and a baseline measure for that particular capture characteristic. In some such embodiments, the baseline measure may include a value for a microphone property or a property of the encoded audio that was used to train the speech recognition model of DSRS 100 and/or is the value for the particular capture characteristic that the speech recognition model uses to match certain sounds to word or textual equivalents.

DSRS 100 performs the speech transcription based on a dynamic adjustment of a speech recognition model with the selected (at 610) first sets of vectors and the selected (at 616) second sets of vectors. Accordingly, DSRS 100 monitors the received (at 604) audio stream for dialog that becomes active.

Process 600 includes detecting (at 618) dialog that is associated with a first user in the first audio stream during a first time in the conference. Process 600 includes dynamically customizing (at 620) the speech recognition model according to the first set of vectors that was selected (at 610) for the first user and the second set of vectors that was selected (at 616) for first audio capture device 101-1 or the operating environment determined (at 614) for first audio capture device 101-1.

Dynamically customizing (at 620) the speech recognition model may include biasing or otherwise adjusting the vectors that represent the speech characteristics with which the speech recognition model recognizes letter, letter combination, syllable, and word sounds to also recognize letter, letter combination, syllable, and word sounds using the speech characteristics represented by the first set of vectors that was selected (at 610) for the first user. The biasing may include modifying the weighting, ordering, and/or definition of certain speech characteristic coefficients in the speech recognition model vectors to reduce or eliminate differences between speech characteristics of the first user and the speech characteristics that were used to train the speech recognition model and that are embedded in the speech recognition model vectors. Dynamically customizing (at 620) the speech recognition model may further include biasing or otherwise adjusting the speech recognition model vectors to account or compensate for the unique or differentiating audio characteristics of the first audio capture device 101-1 and/or the unique or differentiating audio characteristics of the operating environment as represented by the second set of vectors that was selected (at 616) for first audio capture device 101-1. In other words, DSRS 100 biases the vectors or vector coefficients of the speech recognition model so that the speech recognition adapts to the differences in the audio recorded or encoded by the input device that is determined for the first audio stream and in the operating environment of first audio capture device 101-1.

Process 600 includes transcribing (at 622) the dialog that is associated with the first user in the first audio stream during the first time based on the dynamic customization (at 620) of the speech recognition model with the first set of vectors that was selected (at 610) for the first user and the second set of vectors that was selected (at 616) for first audio capture device 101-1 or the operating environment of first audio capture device 101-1. DSRS 100 performs the speech-to-text conversation using the speech recognition model that is adjusted for the unique or differentiating speech characteristics of the first user and for the unique or differentiating audio characteristics of first audio capture device 101-1 and/or the first operating environment.

Process 600 includes detecting (at 624) dialog that is associated with a second user in the second audio stream during a second time in the conference. Process 600 includes dynamically customizing (at 626) the speech recognition model according to a different first set of vectors that was selected (at 610) for the second user and a different second set of vectors that was selected (at 616) for second audio capture device 101-2 or the determined (at 614) operating environment for second audio capture device 101-2. Accordingly, DSRS 100 performs a different adjusting or biasing of the speech recognition model based on the different first set of vectors and the different second set of vectors that are selected for the dialog associated with the second user. For instance, dynamically customizing (at 626) the speech recognition model may include biasing or otherwise adjusting the vectors that represent the speech characteristics with which the speech recognition model recognizes letter, letter combination, syllable, and word sounds to also recognize letter, letter combination, syllable, and word sounds using the speech characteristics represented by the different first set of vectors that was selected (at 610) for the second user. In other words, DSRS 100 dynamically changes the speech recognition model vectors so that the unique or differentiating speech characteristics of the second user are accounted for or used in detecting the words that are spoken by the second user. Similarly, DSRS 100 dynamically changes the speech recognition model vectors so that the unique or differentiating audio characteristics of the input device used by second audio capture device 101-2 to capture the second audio stream or of the operating environment do not affect the audio transcription.

Process 600 include transcribing (at 628) the dialog that is associated with the second user in the second audio stream during the second time based on the dynamic customization (at 626) of the speech recognition model with the different first set of vectors that was selected (at 610) for the second user and the different second set of vectors that was selected (at 616) for second audio capture device 101-2 or the determined (at 614) operating environment for second audio capture device 101-2. The speech recognition proceeds with DSRS 100 dynamically customizing the speech recognition model with the different speaker-specific vectors and the different environment-specific vectors that are associated with different participants speaking during the conference so that speech recognition is continually tuned or modified according to the different modeled speech characteristics of the different participants and the different modeled audio characteristics of the different input devices and environments used by the different participants.

Each of the speech recognition model, speaker adaptation model, and environment adaptation model used by DSRS 100 may correspond to different machine learning models. Each machine learning model may be trained using a different machine learning algorithm. For instance, the speech recognition model is trained for generalized speech recognition and transcription, whereas the speaker adaptation model is trained to detect and define different speech characteristics of different speakers.

Once trained, input is applied to the machine learning model to make a prediction, which may also be referred to herein as a predicated output or output. For instance, the predictions of the speech recognition model may include text that is detected for different snippets of audio, the predictions of the speaker adaptation model may include differences between a particular speaker speaking a word or phrase a baseline audio representation of that word or phrase, and the predictions of the environment adaptation model may include affects that audio capture device or an environment impart on captured audio within an encoded audio stream.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depend on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicted output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning excels at include clustering, classification, regression, anomaly detection, prediction, and dimensionality reduction (i.e., simplification). Examples of machine learning algorithms include decision trees, support vector machines (“SVM”), Bayesian networks, stochastic algorithms such as genetic algorithms (“GA”), and connectionist topologies such as artificial neural networks (“ANN”). Implementations of machine learning may rely on matrices, symbolic models, and hierarchical and/or associative data structures. Parameterized (i.e., configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

An ANN is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (“MLP”), each layer comprises a group of synapses or neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neurons.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N [L−1] and N [L], respectively, the dimensions of matrix W is N [L−1] columns and N [L] rows.

Biases for a particular layer L may also be stored in matrix B having one column with N [L] rows.

The matrices W and B may be stored as a vector or an array in random access memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as a vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need to be computed, and/or less derivative values need to be computed during training.

Properties of matrices used to implement a neural network correspond to neurons (i.e., synapses) and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (“SIMD”), such as with a graphical processing unit (“GPU”). Matrix partitioning may achieve horizontal scaling such as with symmetric multiprocessing (“SMP”) such as with a multicore central processing unit (“CPU”) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e., amount of layers) may cause computational latency. Deep learning entails endowing a MLP with many layers. Each layer achieves data abstraction, with complicated (i.e., multidimensional as with several inputs) abstractions needing multiple layers that achieve cascaded processing.

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e., completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward MLP, including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e., correct) output is already known for each example in a training set. The training set is configured in advance by (e.g., a human expert) assigning a categorization label to each example. For example, the training set for optical character recognition may have blurry photographs of individual letters, and an expert may label each photo in advance according to which letter is shown. Error calculation and backpropagation occur as explained above.

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g., anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2 (1): 1-18 by Jinwon An et al.

Principal component analysis (“PCA”) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other machine learning algorithms.

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

The embodiments presented above are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the above descriptions are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (“IoT”) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (“RF”), infrared and other wireless media. Combinations of any of the above can also be included within the scope of computer-readable storage media.

Computer storage media can include volatile and nonvolatile, removable and non-removable media implemented in any method or technology for storage of information such as computer-readable instructions, data structures, program modules, or other data. Computer storage media can include, but is not limited to, random access memory (“RAM”), read only memory (“ROM”), electrically erasable programmable ROM (“EEPROM”), flash memory, or other memory technology, compact disk ROM (“CD-ROM”), digital versatile disks (“DVDs”) or other optical storage, solid state drives, hard drives, hybrid drive, or any other medium that can be used to store the desired information and that can be accessed to retrieve that information.

It is appreciated that the presented systems and methods can be implemented in a variety of architectures and configurations. For example, the systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

It should be understood, that terms “user” and “participant” have equal meaning in the following description.

1. A computer-implemented method for audio transcription, the computer-implemented method comprising:
receiving an audio stream from a user device;
identifying a particular user that speaks in the audio stream;
selecting at least a first vector from a first plurality of vectors generated by a first machine learning model, wherein the first vector is encoded with speech characteristics of the particular user;
selecting at least a second vector from a second plurality of vectors generated by a second machine learning model, wherein the second vector is encoded with audio characteristics that affect a capture of the audio stream;
adjusting a third machine learning model based on the speech characteristics encoded within the first vector and the audio characteristics encoded within the second vector; and
using the third machine learning model to convert speech of the particular user into text after said adjusting.

2. The computer-implemented method of claim 1, further comprising:
identifying a second user that speaks in the audio stream during a time that is different than when the particular user speaks;
selecting at least a third vector from the first plurality of vectors, wherein the third vector is encoded with speech characteristics of the second user that are different than the speech characteristics of the particular user;
adjusting the third machine learning model based on the speech characteristics encoded within the third vector; and
converting speech of the second user into text based on the third machine learning model after adjusting based on the speech characteristics encoded within the third vector.

3. The computer-implemented method of claim 1, further comprising:
determining an audio capture device that records or encodes the audio stream; and
wherein selecting the second vector comprises determining that the audio characteristics encoded within the second vector correspond to capture characteristics with which the audio capture device records or encodes the audio stream.

4. The computer-implemented method of claim 3, wherein the capture characteristics represent one or more adjustments that are made to the speech of the particular user in the audio stream as a result of recording or encoding the speech with the audio capture device.

5. The computer-implemented method of claim 1, further comprising:
receiving identifying information with the audio stream;
determining an environment in which the particular user is located based on the identifying information; and
wherein selecting the second vector comprises determining that the audio characteristics encoded within the second vector correspond to acoustic characteristics of the environment.

6. The computer-implemented method of claim 5, wherein the acoustic characteristics correspond to sounds that are added to the speech of the particular user in the audio stream based on environmental factors associated with the environment.

7. The computer-implemented method of claim 1, wherein adjusting the third machine learning model comprises:
modifying a vector of the third machine learning model, that represents a first sound for recognizing one or more letters in the speech according to a first set of speech characteristics, based on the first vector being encoded with a second set of speech characteristics that represent a second sound for recognizing the one or more letters in the speech.

8. The computer-implemented method of claim 1, further comprising:
receiving a first audio sample of the particular user speaking and a second audio sample of a second user speaking;
determining a first set of speech characteristics associated with the particular user speaking and a second set of speech characteristics associated with the second user speaking; and
generating a first set of vectors of the first plurality of vectors that encode the first set of speech characteristics, and a second set of vectors of the first plurality of vectors that encode the second set of speech characteristics, wherein first set of vectors comprises the first vector, and wherein the second set of vectors comprises the second vector.

9. The computer-implemented method of claim 8 further comprising:
associating the first set of vectors to one or more identifiers associated with the particular user; and
associating the second set of vectors to one or more identifiers associated with the second user.

10. The computer-implemented method of claim 1, further comprising:
receiving an audio sample of the particular user speaking;
comparing the audio sample to a set of audio samples used in training the third machine learning model;
determining differences between the speech characteristics of the particular user and speech characteristics associated with the set of audio samples; and
generating the first vector to encode one or more of the differences.

11. The computer-implemented method of claim 1, further comprising:
training the third machine learning model to recognize words in speech according to a first set of speech characteristics; and
wherein adjusting the third machine learning model comprises biasing one or more of the first set of speech characteristics to recognize one or more of the words according to the speech characteristics encoded within the first vector.

12. The computer-implemented method of claim 1, further comprising:
training the third machine learning model with audio samples that are recorded or encoded with a first set of audio characteristics; and
wherein adjusting the third machine learning model comprises:
biasing one or more of the first set of audio characteristics that differ from the audio characteristics encoded within the second vector; and
performing speech recognition that compensates for differences between the first set of audio characteristics used to train the third machine learning model and the audio characteristics encoded within the second vector in response to biasing the one or more of the first set of audio characteristics.

13. The computer-implemented method of claim 1, wherein adjusting the third machine learning model comprises:
modifying a first vector value of the third machine learning model representing a particular speech characteristic with a different value that is specified for the same particular speech characteristic in the first vector; and
modifying a second vector value of the third machine learning model representing a particular audio characteristic with a different value that is specified for the same particular audio characteristic in the second vector.

14. The computer-implemented method of claim 1, further comprising:
identifying an input device that captures the audio stream; and
wherein selecting the second vector comprises selecting a vector from the second plurality of vectors that represents properties with which the input device capture the audio stream.

15. The computer-implemented method of claim 1, wherein the first machine learning model is a speaker adaptation model, the second machine learning model is an environment adaptation model, and the third machine learning model is a speech recognition model comprising vectors for detecting and transcribing spoken words to text.

16. A system for automated speech recognition, the system comprising:
one or more hardware processors configured to:
receive an audio stream from a user device;
identify a particular user that speaks in the audio stream;
select at least a first vector from a first plurality of vectors generated by a first machine learning model, wherein the first vector is encoded with speech characteristics of the particular user;
select at least a second vector from a second plurality of vectors generated by a second machine learning model, wherein the second vector is encoded with audio characteristics that affect a capture of the audio stream;
adjust a third machine learning model based on the speech characteristics encoded within the first vector and the audio characteristics encoded within the second vector; and
use the third machine learning model to convert speech of the particular user into text after said adjusting.

17. The system of claim 16, wherein the one or more hardware processors are further configured to:
identify a second user that speaks in the audio stream during a time that is different than when the particular user speaks;
select at least a third vector from the first plurality of vectors, wherein the third vector is encoded with speech characteristics of the second user that are different than the speech characteristics of the particular user;
adjust the third machine learning model based on the speech characteristics encoded within the third vector; and
convert speech of the second user into text based on the third machine learning model after adjusting based on the speech characteristics encoded within the third vector.

18. The system of claim 16, wherein the one or more hardware processors are further configured to:
determine an audio capture device that records or encodes the audio stream; and
wherein selecting the second vector comprises determining that the audio characteristics encoded within the second vector correspond to capture characteristics with which the audio capture device records or encodes the audio stream.

19. The system of claim 16, wherein the one or more hardware processors are further configured to:
receive identifying information with the audio stream;
determine an environment in which the particular user is located based on the identifying information; and
wherein selecting the second vector comprises determining that the audio characteristics encoded within the second vector correspond to acoustic characteristics of the environment.

20. A non-transitory computer-readable medium storing program instructions that, when executed by one or more hardware processors of a speech recognition system, cause the speech recognition system to perform operations comprising:
receive an audio stream from a user device;
identify a particular user that speaks in the audio stream;
select at least a first vector from a first plurality of vectors generated by a first machine learning model, wherein the first vector is encoded with speech characteristics of the particular user;
select at least a second vector from a second plurality of vectors generated by a second machine learning model, wherein the second vector is encoded with audio characteristics that affect a capture of the audio stream;
adjust a third machine learning model based on the speech characteristics encoded within the first vector and the audio characteristics encoded within the second vector; and
use the third machine learning model to convert speech of the particular user into text after said adjusting.
